(19) United States
(12) Patent Application Publication
(10) Pub. No.: US 2004/0221216 A1
(43) Pub. Date: Nov. 4, 2004

(54) Amplitude selection

(76) Inventor: David S. Nack, Roseville, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/397,947

(22) Filed: Mar. 25, 2003

(51) Int. Cl. G06F 11/00

(52) U.S. Cl. 714/745

(57) ABSTRACT

In one embodiment, a method is provided. In the method of this embodiment, a first range of amplitudes may be selected from a plurality of ranges of amplitudes. The first range of amplitudes may include a first amplitude of a signal received via a communication medium. The method of this embodiment may also include selecting a second amplitude of a signal to be transmitted via the communication medium. The second amplitude may be included in a second range of amplitudes included in the plurality of ranges of amplitudes. The second amplitude may be selected based, at least in part, upon the selected first range of amplitudes. Of course, many alternatives, variations, and modifications are possible without departing from this embodiment.

### FIELD

This disclosure relates to the field of amplitude selection.

### BACKGROUND

In one conventional network, the network includes a plurality of network nodes. The nodes include network interfaces that are coupled to a communication medium. Each network interface transmits and receives signals via the communication medium that encode, in accordance with a communication protocol, information. In this conventional network, the communication protocol specifies certain network characteristics and/or parameters, such as, a predetermined transmission amplitude that signals supplied by the network interfaces to the communication medium are expected to have, a maximum displacement of the communication medium that is permitted to exist between any two network interfaces, and a maximum signal attenuation that is permitted to exist per unit of communication medium displacement between any two network interfaces. Thus, the protocol also defines a maximum expected attenuation of a signal propagated from one network interface to another network interface via the communication medium. Typically, the predetermined transmission amplitude specified in the protocol is chosen so as to permit the amplitude of a signal received by a receiving network interface, after the signal undergoes the maximum expected attenuation as a result of its propagation through the communication medium, to be at least minimally sufficient to permit the signal to be detected, and the information encoded by the signal to be reliably decoded, by the receiving network interface.

In many cases, the actual attenuation of a signal propagated via the communication medium is less than the maximum expected attenuation. In such cases, the signal, as supplied to the communication medium, has an amplitude that this greater than that minimally sufficient, given the actual attenuation that the signal undergoes in propagating through the communication medium, to permit the signal to be detected, and the information reliably encoded, by a receiving network interface. This may result in the transmitting network interface consuming and/or dissipating more power than would be sufficient to generate and transmit to the receiving network interface a signal having an amplitude that is minimally sufficient, given this actual attenuation, to permit the signal to be detected, and the information encoded by the signal to be reliably decoded, by the receiving network interface.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a network.

FIG. 2 illustrates a system embodiment.

FIG. 3 is a flowchart illustrating operations that may be performed according to an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

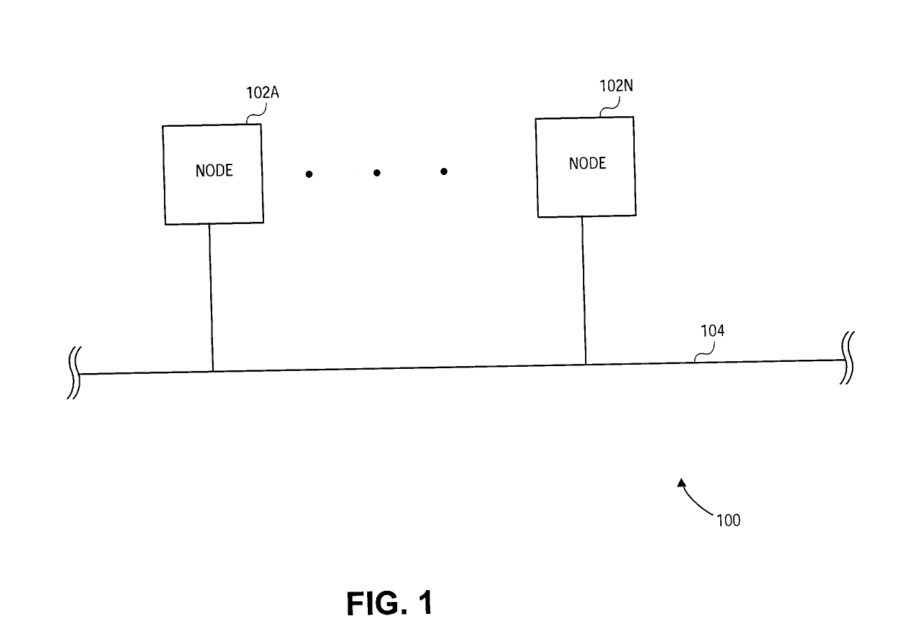

FIG. 1 illustrates one example of a network 100. Network 100 may comprise, for example, one or more computer nodes 102A . . . 102N communicatively coupled together via a communication medium 104. Nodes 102A . . . 102N may transmit and receive sets of one or more signals via medium 104 that may encode one or more packets.

As used herein, a “packet” means a sequence of one or more values that may be transmitted from at least one sender to at least one receiver. As used herein, a “communication medium” means any physical entity through which electromagnetic radiation may be transmitted and/or received.

In this embodiment, medium 104 may comprise, for example, one or more optical and/or electrical cables, although many alternatives are possible without departing from this embodiment. For example, without departing from this embodiment, medium 104 may comprise a medium, such as, for example, air and/or vacuum, through which nodes 102A . . . 102N may wirelessly transmit and/or receive sets of one or more signals.

Unless stated to the contrary herein, in this embodiment, signals and/or packets transmitted and/or received among two or more of the nodes 102A . . . 102N via medium 104 may be compatible and/or in compliance with an Ethernet communication protocol, e.g., 10BaseT Ethernet communication protocol described in, for example, Institute of Electrical and Electronics Engineers, Inc. (IEEE) Std. 802.3, 2000 Edition, published on Oct. 20, 2000. Of course, signals and/or packets transmitted and/or received via medium 104 may be compatible and/or in compliance with one or more other communication protocols, without departing from this embodiment.

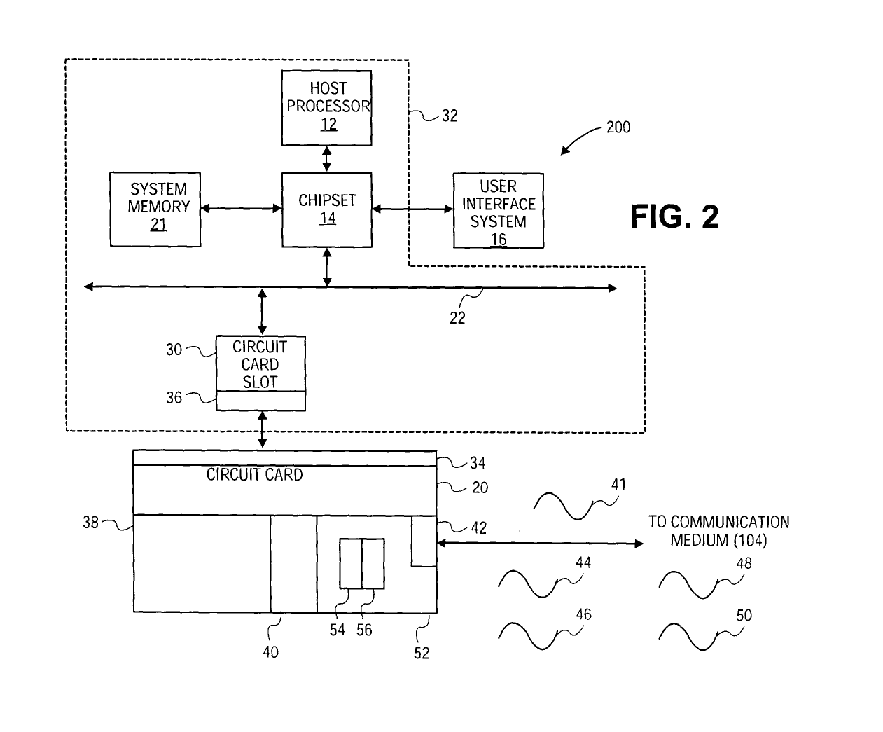

FIG. 2 illustrates the construction of a system embodiment 200 of the claimed subject matter. In network 100, each of the nodes 102A . . . 102N may comprise one or more respective systems that may be substantially identical (e.g., in terms of construction and/or operation) to system 200. Alternatively, without departing from this embodiment, one or more of the nodes 102A . . . 102N may not comprise one or more systems that are substantially identical to system 200.

In network 100, one or more the nodes 102A . . . 102N may comprise one or more intermediate stations, such as, for example, one or more hubs, switches, and/or routers; additionally or alternatively, one or more of the nodes 102A . . . 102N may comprise one or more end stations. Also additionally or alternatively, network 100 may comprise one or more not shown intermediate stations, and medium 104 may communicatively couple together at least some of the nodes 102A . . . 102N and one or more of these intermediate stations. Of course, many alternatives are possible without departing from this embodiment.

As shown in FIG. 2, system 200 may include a host processor 12 coupled to a chipset 14. Host processor 12 may comprise, for example, an Intel® Pentium® III or IV microprocessor that is commercially available from the Assignee of the subject application. Of course, alternatively, host processor 12 may comprise another type of microprocessor, such as, for example, a microprocessor that is manufactured and/or commercially available from a source other than the Assignee of the subject application, without departing from this embodiment.

Chipset 14 may comprise a host bridge/hub system that may couple host processor 12, a system memory 21 and a user interface system 16 to each other and to a bus system 22. Chipset 14 may also include an I/O bridge/hub system (not shown) that may couple the host bridge/bus system to bus 22. Chipset 14 may comprise integrated circuit chips, such as those selected from integrated circuit chipsets commercially available from the Assignee of the subject application (e.g., graphics memory and I/O controller hub chipsets), although other integrated circuit chips may also, or alternatively be used, without departing from this embodiment. User interface system 16 may comprise, e.g., a keyboard, pointing device, and display system that may permit a human user to input commands to, and monitor the operation of, system 200.

Bus 22 may comprise a bus that complies with the Peripheral Component Interconnect (PCI) Local Bus Specification, Revision 2.2, Dec. 18, 1998 available from the PCI Special Interest Group, Portland, Oreg., U.S.A. (hereinafter referred to as a “PCI bus”). Alternatively, bus 22 instead may comprise a bus that complies with the PCI-X Specification Rev. 1.0a, Jul. 24, 2000, available from the aforesaid PCI Special Interest Group, Portland, Oreg., U.S.A. (hereinafter referred to as a “PCI-X bus”). Also alternatively, bus 22 may comprise other types and configurations of bus systems, without departing from this embodiment.

Processor 12, system memory 21, chipset 14, PCI bus 22, and circuit card slot 30 may be comprised in a single circuit board, such as, for example, a system motherboard 32. Circuit card slot 30 may comprise a PCI expansion slot that comprises a PCI bus connector 36. Connector 36 may be electrically and mechanically mated with a PCI bus connector 34 that is comprised in circuit card 20. Slot 30 and card 20 may be constructed to permit card 20 to be inserted into slot 30. When card 20 is properly inserted into slot 30, connectors 34 and 36 may become electrically and mechanically coupled to each other. When connectors 34 and 36 are so coupled to each other, operative circuitry 38 in card 20 becomes electrically coupled to bus 22.

When circuitry 38 is electrically coupled to bus 22, host processor 12 may exchange data and/or commands with circuitry 38, via chipset 14 and bus 22 that may permit host processor 12 to control and/or monitor the operation of circuitry 38. Circuitry 38 may include network interface circuitry 40. Circuitry 40 may comprise computer-readable memory 52 and transceiver circuitry 42. Memory 52 may comprise read only and/or random access memory that may store one or more lookup tables 54 and program instructions 56. These program instructions 56, when executed, for example, by operative circuitry 38, network interface circuitry 40, and/or transceiver circuitry 42 may result in, among other things, circuitry 38, circuitry 40, and/or circuitry 42 executing operations that may result in system 200 carrying out the operations described herein as being carried out by system 200.

Without departing from this embodiment, instead of being comprised in card 20, some or all of operative circuitry 38 may be comprised in other structures, systems, and/or devices that may be, for example, comprised in motherboard 32, coupled to bus 22, and exchange data and/or commands with other components in system 200. Additionally, without departing from this embodiment, system 200 may include a plurality of cards, identical in construction and/or operation to card 20, coupled to bus 22 via a plurality of circuit card slots identical in construction and/or operation to slot 30.

Transceiver circuitry 42 may be communicatively coupled to medium 104. As stated previously, in this embodiment, medium 104 may comprise one or more optical and/or electrical cables. In this embodiment, circuitry 42 may be optically and/or electrically coupled to, and may be capable of transmitting and receiving signals via, these one or more cables.

One or more lookup tables 54 may comprise, for example, a plurality of lookup tables. For purposes described below, these lookup tables may correlate, for example, a plurality of ranges of signal amplitudes with respective predetermined signal transmission amplitudes. As used herein, a range of amplitudes may comprise one or more amplitudes. Each of these predetermined signal transmission amplitudes may be comprised in a respective one of the plurality of ranges of signal amplitudes.

For example, in this embodiment, the plurality of ranges of signals amplitudes may comprise four ranges of amplitudes: a first amplitude range, a second amplitude range, a third amplitude range, and a fourth amplitude range. The first amplitude range may comprise signal amplitudes that are greater than 2.2 volts of peak-to-peak signal amplitude, but less than or equal to 2.8 volts of peak-to-peak signal amplitude. The second amplitude range may comprise may comprise signal amplitudes that are less than or equal to 2.2 volts of peak-to-peak signal amplitude, but greater than 1.7 volts of peak-to-peak signal amplitude. The third amplitude range may comprise signal amplitudes that are less than or equal to 1.7 volts of peak-to-peak signal amplitude, but greater than 1.2 volts of peak-to-peak signal amplitude. The fourth amplitude range may comprise signal amplitudes that are less than or equal to 1.2 volts of peak-to-peak signal amplitude, but greater than 0.8 volts of peak-to-peak signal amplitude.

The predetermined signal transmission amplitudes may comprise, for example, four predetermined signal transmission amplitudes: a first predetermined signal transmission amplitude, a second predetermined signal transmission amplitude, a third predetermined signal transmission amplitude, and a fourth predetermined signal transmission amplitude. The first predetermined signal transmission amplitude may be equal to a predetermined signal transmission amplitude in accordance with a communication protocol via which communication may be established and/or maintained, at least in part, between two or more of the nodes 102A . . . 102N in network 100. For example, in this embodiment, nodes 102A and 102N may transmit and/or receive signals and/or packets via medium 104 in accordance, at least in part, with an Ethernet communication protocol, and the first predetermined signal transmission amplitude may be equal to a predetermined signal transmission amplitude, according to such protocol, of 2.5 volts peak-to-peak. That is, in order to be in compliance with such protocol, a signal, when transmitted, may be expected to have a predetermined peak-to-peak amplitude of 2.5 volts. In this embodiment, the second predetermined signal transmission amplitude may be equal to 2.0 volts peak-to-peak, the third predetermined signal transmission amplitude may be equal to 1.5 volts peak-to-peak, and the fourth predetermined signal transmission amplitude may be equal to 1.0 volt peak-to-peak. Of course, the specific ranges of amplitudes and predetermined signal transmission amplitudes may vary without departing from this embodiment.

In this embodiment, one or more tables 54 may comprise a first lookup table and a second lookup table. The first lookup table may correlate the first, second, third, and fourth ranges of amplitudes with the fourth, third, second, and first predetermined signal transmission amplitudes, respectively. The second lookup table may correlate the first, second, and third ranges of amplitudes with the third, second, and first predetermined signal transmission amplitudes, respectively; the second lookup table also may correlate the fourth range of amplitudes with the first predetermined signal transmission amplitude. Of course, the number of tables comprised in tables 54 and the manner in which tables 54 may correlate the plurality of ranges of amplitudes with the predetermined signal transmission amplitudes may vary without departing from this embodiment.

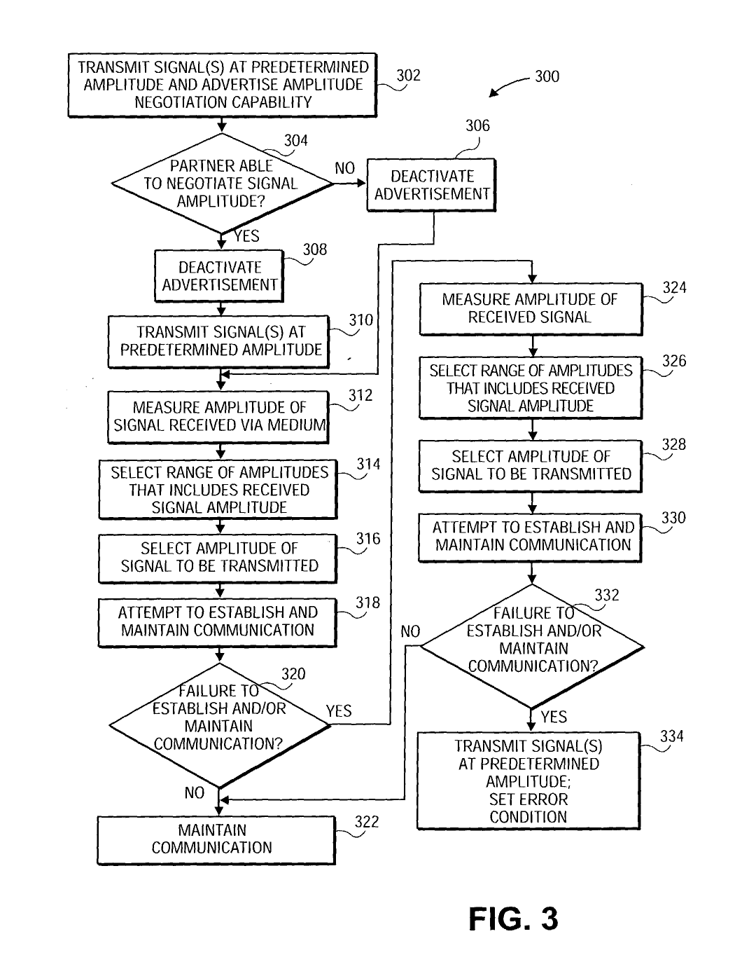

With particular reference now being made to FIG. 3, operations 300 that may be carried out in system 200 in accordance with one embodiment will be described. For purposes of the present discussion, system 200 will be described as being comprised in node 102A. However, as stated previously, each of the nodes 102A . . . 102N in network 100 may comprise a respective system that is identical to system 200. Thus, each of the nodes 102A . . . 102N may be capable of executing respective sets of operations that may be substantially identical to operations 300; these sets of operations may be executed substantially contemporaneously in network 100, alternatively, one or more of these sets of operations may not be executed contemporaneously with one or more other sets of such operations.

After, for example, a reset of card 20 and/or system 200, circuitry 40 may signal circuitry 42. As illustrated by operation 302 in FIG. 3, this may result in circuitry 42 transmitting one or more signals 41 having the first predetermined signal transmission amplitude to an intended communication partner (e.g., node 102N) in network 100 via medium 104; these one or more signals 41 may encode one or more packets that may advertise the capability of circuitry 40 to negotiate (i.e., to select in accordance with this embodiment) an amplitude for signals to be transmitted by circuitry 42 to node 102N, and vice versa. These one or more signals may be in compliance and/or compatible with, e.g., auto-negotiation next pages according to an Ethernet communication protocol. These one or more packets may comprise and/or specify, e.g., one or more addresses that may identify node 102A and/or circuitry 40. In response, at least in part, to receipt of such signals 41, if node 102N is capable of negotiating (i.e., selecting in accordance with this embodiment) an amplitude for signals to be transmitted by node 102N to circuitry 42, node 102N may transmit to circuitry 42 via medium 104 one or more signals that may encode one or more packets that may advertise this capability. If circuitry 42 receives, during a predetermined time period, these one or more signals from node 102N, circuitry 40 may determine, as a result of operation 304 in FIG. 3, that the intended communication partner (i.e., node 102N) in network 100 is capable of such negotiating. Conversely, if circuitry 42 does not receive these one or more signals from node 102N during this predetermined time period, circuitry 40 may determine, as a result of operation 304, that the intended communication partner (i.e., node 102N) does not have this capability.

If, as a result of operation 304, circuitry 40 determines that node 102N is not capable of such negotiation, circuitry 40 may signal circuitry 42. This may result in circuitry 42 ceasing to transmit one or more signals 41 that may encode the one or more packets that may advertise this capability of circuitry 40, as illustrated by operation 306 in FIG. 3. Circuitry 40 may then detect and/or measure an amplitude of a signal 44 received by circuitry 42, via medium 104, from node 102N, as illustrated by operation 312 in FIG. 3.

Conversely, if, as a result of operation 304, circuitry 40 determines that node 102A is capable of such negotiation, circuitry 40 may signal circuitry 42. This may result in circuitry 42 ceasing to transmit one or more signals 41 that may encode the one or more packets that may advertise this capability of circuitry 40, as illustrated by operation 308 in FIG. 3. Thereafter, circuitry 40 may again signal circuitry 42. This may result in circuitry 42 transmitting to node 102N, via medium 104, one or more pulse signals having the first predetermined amplitude and also having a predetermined duration, as illustrated by operation 310 in FIG. 3. For example, each of the one or more pulse signals may have a respective duration of one second. Of course, many variations are possible without departing from this embodiment. Circuitry 40 also may detect and/or measure, as a result of operation 312, an amplitude of a signal 44 received by circuitry 42, via medium 104, from node 102N.

In accordance with this embodiment, the amplitude of signal 44 detected and/or measured as a result of operation 312 may indicate, at least in part, a signal attenuation characteristic (i.e., the amount of actual attenuation that may be imparted to a signal propagated between circuitry 42 and node 102N via medium 104) of medium 104. For example, regardless of whether node 102N is capable of carrying out signal amplitude negotiations, in this embodiment, the amplitude of signal 44, as initially propagated to medium 104 from node 102N, may be expected to be equal to the first predetermined signal transmission amplitude. Accordingly, the degree to which the amplitude of signal 44, as detected and/or measured by circuitry 40, is attenuated relative to the predetermined signal transmission amplitude may indicate a signal attenuation characteristic of medium 104 with respect to signal 44.

After operation 312 has been carried out, circuitry 40 may examine the first table comprised in one or more tables 54, and may select, as illustrated by operation 314, from the plurality of ranges of amplitudes correlated in the first table, one of the plurality of ranges of amplitudes that comprises the amplitude of the signal detected and/or measured by circuitry 40, as a result of operation 312. Thereafter, as illustrated by operation 316, circuitry 40 may select, as an amplitude of one or more signals to be transmitted by circuitry 42 to node 102N via medium 104, the predetermined signal transmission amplitude that is correlated with the one of the plurality of the ranges of amplitudes selected as a result of operation 314. For example, if the one of the plurality of ranges of amplitudes selected as a result of operation 314 is the first range of amplitudes, then circuitry 40 may select, as a result of operation 316, the fourth predetermined signal transmission amplitude. Conversely, if the one of the plurality of ranges of amplitudes selected as a result of operation 314 is the second range of amplitudes, then circuitry 40 may select, as a result of operation 316, the third predetermined signal transmission amplitude. Also conversely, if the one of the plurality of ranges of amplitudes selected as a result of operation 314 is the third range of amplitudes, then circuitry 40 may select, as a result of operation 316, the second predetermined signal transmission amplitude. Further conversely, if the one of the plurality of ranges of amplitudes selected as a result of operation 314 is the fourth range of amplitudes, then circuitry 40 may select, as a result of operation 316, the first predetermined signal transmission amplitude.

After operation 316 has been carried out, circuitry 40 may attempt to establish and maintain communication with node 102N, as illustrated by operation 318. For example, circuitry 40 may signal circuitry 42. This may result in circuitry 42 transmitting to node 120N via medium 104 one or more signals 46 having the predetermined signal transmission amplitude selected by circuitry 40 as a result of operation 316. One or more signals 46 may encode one or more packets that may specify and/or comprise commands that, when executed by node 102N, may result in establishing and/or maintaining of communication between circuitry 40 and node 102N, in accordance, at least in part, with a communication protocol, such as, for example, an Ethernet communication protocol. As a result or consequence, at least in part, of the establishment and/or maintaining of such communication, node 102N may be expected to transmit to circuitry 42 via medium 104 one or more signals that may encode one or packets that may specify and/or comprise data and/or commands that may be indicative of, comprised in, and/or incidental to such communication. However, in this embodiment, if node 102N is unable to decode from one or more signals 46 these one or more packets encoded in one or more signals 46, such communication may not be established and/or maintained between circuitry 40 and node 102N. In accordance with this embodiment, if circuitry 42 does not receive and/or continue to receive via medium 104, within one or more predetermined time periods following transmission of one or more signals 46, one or more signals that may encode one or more packets that may specify and/or comprise data and/or commands that may be indicative of, comprised in, and/or incidental to such communication, circuitry 40 may determine, as a result of operation 320, that failure to establish and/or maintain such communication has occurred. Conversely, if circuitry 42 does not fail to receive and/or continue to receive via medium 104, within one or more predetermined time periods following transmission of one or more signals 46, one or more signals that may encode one or more packets that may specify and/or comprise data and/or commands that may be indicative of, comprised in, and/or incidental to such communication, circuitry 40 may determine, as a result of operation 320, that failure to establish and/or maintain such communication has not occurred.

If circuitry 40 determines, as a result of operation 320, that no failure to establish and/or maintain such communication has occurred, circuitry 40 may signal circuitry 42 to continue to maintain communication with node 102N, in accordance at least in part with a communication protocol, such as, for example, an Ethernet protocol. This may result in circuitry 42 continuing to transmit one or more signals having the predetermined signal transmission amplitude that may encode one or more packets that may specify and/or comprise data and/or commands that, when received by node 102N, may result in node 102N continuing to communicate with circuitry 42 via medium 104, as illustrated by operation 322 in FIG. 3.

Conversely, if circuitry 40 determines, as a result of operation 320, that failure to establish and/or maintain such communication has occurred, circuitry 40 may detect and/or measure, as a result of operation 324, an amplitude of a signal 48 received by circuitry 42, via medium 104, from node 102N. In accordance with this embodiment, the amplitude of signal 48 detected and/or measured as a result of operation 324 may indicate, at least in part, a signal attenuation characteristic of medium 104. For example, in this embodiment, node 102N may comprise a system that may operate in a manner identical to system 200, and medium 104 may be expected to have the same signal attenuation characteristic (or substantially similar attenuation characteristic, e.g., for purposes of carrying out this embodiment) regardless of whether a signal is being transmitted from circuitry 42 to node 102N, or from node 102N to circuitry 42. Accordingly, the degree to which the amplitude of signal 48, as detected and/or measured by circuitry 40, is attenuated relative to the predetermined signal transmission amplitude selected as a result of operation 316 may indicate a signal attenuation characteristic of medium 104 with respect to signal 48.

After operation 324 has been carried out, circuitry 40 may examine the second table comprised in one or more tables 54, and may select, as illustrated by operation 326, from the plurality of ranges of amplitudes correlated in the second table, one of the plurality of ranges of amplitudes that comprises the amplitude of the signal 48 detected and/or measured by circuitry 40, as a result of operation 324. Thereafter, as illustrated by operation 328, circuitry 40 may select, as an amplitude of one or more signals 50 to be transmitted by circuitry 42 to node 102N via medium 104, the predetermined signal transmission amplitude that is correlated, in the second table in one or tables 54, with the one of the plurality of the ranges of amplitudes selected as a result of operation 326. For example, if the one of the plurality of ranges of amplitudes selected as a result of operation 326 is the first range of amplitudes, then circuitry 40 may select, as a result of operation 328, the third predetermined signal transmission amplitude. Conversely, if the one of the plurality of ranges of amplitudes selected as a result of operation 326 is the second range of amplitudes, then circuitry 40 may select, as a result of operation 328, the second predetermined signal transmission amplitude. Also conversely, if the one of the plurality of ranges of amplitudes selected as a result of operation 326 is the third range of amplitudes, then circuitry 40 may select, as a result of operation 328, the first predetermined signal transmission amplitude. Further conversely, if the one of the plurality of ranges of amplitudes selected as a result of operation 326 is the fourth range of amplitudes, then circuitry 40 may select, as a result of operation 328, the first predetermined signal transmission amplitude.

After operation 328 has been carried out, circuitry 40 may attempt to establish and maintain communication with node 102N, as illustrated by operation 330. For example, circuitry 40 may signal circuitry 42. This may result in circuitry 42 transmitting to node 120N via medium 104 one or more signals 50 having the predetermined signal transmission amplitude selected by circuitry 40 as a result of operation 328. One or more signals 50 may encode one or more packets that may specify and/or comprise commands, that, when executed by node 102N, may result in establishing and/or maintaining of communication between circuitry 40 and node 102N, in accordance, at least in part, with a communication protocol, such as, for example, an Ethernet communication protocol. As a result or consequence, at least in part, of the establishment and/or maintaining of such communication, node 102N may be expected to transmit to circuitry 42 via medium 104 one or more signals that may encode one or packets that may specify and/or comprise data and/or commands that may be indicative of, comprised in, and/or incidental to such communication. However, in this embodiment, if node 102N is unable to decode from one or more signals 50 these one or more packets encoded in one or more signals 50, such communication may not be established and/or maintained between circuitry 40 and node 102N. In accordance with this embodiment, if circuitry 42 does not receive and/or continue to receive via medium 104, within one or more predetermined time periods following transmission of one or more signals 50, one or more signals that may encode one or more packets that may specify and/or comprise data and/or commands that may be indicative of, comprised in, and/or incidental to such communication, circuitry 40 may determine, as a result of operation 332, that failure to establish and/or maintain such communication has occurred. Conversely, if circuitry 42 does not fail to receive and/or continue to receive via medium 104, within one or more predetermined time periods following transmission of one or more signals 50, one or more signals that may encode one or more packets that may specify and/or comprise data and/or commands that may be indicative of, comprised in, and/or incidental to such communication, circuitry 40 may determine, as a result of operation 332, that failure to establish and/or maintain such communication has not occurred.

If circuitry 40 determines, as a result of operation 332, that no failure to establish and/or maintain such communication has occurred, circuitry 40 may signal circuitry 42. This may result in circuitry 42 carrying out operation 322 in the manner described previously to maintain communication between circuitry 40 and node 102N. Circuitry 40 may periodically re-evaluate, in the manner described previously, whether failure to maintain such communication has occurred; if such failure has occurred, circuitry 40 may re-commence operations 300, starting with operation 302.

Conversely, if circuitry 40 determines, as a result of operation 332, that failure to establish and/or maintain such communication has occurred, circuitry 40 may signal circuitry 42. This may result in circuitry 40 ceasing to negotiate with node 102N the amplitude of one or more signals to be transmitted via medium 104, and any additional signals transmitted by circuitry 42 via medium 104 may have the first predetermined signal transmission amplitude. This may also result in storing in, e.g., one or more registers (not shown) in circuitry 38 of one or more values that may indicate that an error may have occurred during negotiation with node 102N of the amplitude of one or more signals to be transmitted via medium 104. Host processor 12 may be capable of examining these values to determine that such an error may have occurred.

As stated above, the amplitude of signals 44 and 48 detected and/or measured as a result of operation 312 and operation 324, respectively, may indicate a signal attenuation characteristic of medium 104. The correlations, in tables 54, among the plurality of ranges of amplitudes and predetermined signal transmission amplitudes may be selected in such a way as to permit the signal attenuation characteristic of medium 104 to be taken into account when selecting the amplitudes of signals 46 and 50 to be transmitted from circuitry 42 to node 102N via medium 104. For example, these correlations may permit the predetermined signal transmission amplitudes selected as a result of operation 316 and 328 and to be relatively elevated or reduced, depending upon whether the signal attenuation characteristic of medium 104 indicated by the amplitudes detected and/or measured as a result of operation 312 and 324 is more elevated or reduced, respectively. Advantageously, in this embodiment, depending upon the predetermined signal transmission amplitude so selected and utilized to carry out communication between circuitry 40 and node 102N, less power may be consumed and/or dissipated by circuitry 40 to generate and/or transmit signals from circuitry 42 to node 102N, compared to the prior art. Indeed, in at least certain implementations of system 200, the power consumed and/or dissipated by circuitry 40 to generate and/or transmit signals from circuitry 42 to node 102N may approach that minimally sufficient, given the signal attenuation characteristic of medium 104, to permit such signals to be detected, and the information encoded by such signals to be reliably decoded, by the node 102N.

Thus, in summary, one system embodiment may comprise a circuit board that may comprise a circuit card slot. The circuit card may be capable of being coupled to the slot. The circuit card may comprise circuitry to select, from a plurality of ranges of amplitudes, a first range of amplitudes that may include a first amplitude of a signal received via a communication medium. The circuitry may also be capable of selecting a second amplitude of a signal to be transmitted via the communication medium. The second amplitude may be comprised in a second range of amplitudes comprised in the plurality of ranges of amplitudes. The circuitry may be capable of selecting the second amplitude based, at least in part, upon the selected first range of amplitudes.

The terms and expressions which have been employed herein are used as terms of description and not of limitation, and there is no intention, in the use of such terms and expressions, of excluding any equivalents of the features shown and described (or portions thereof), and it is recognized that various modifications, variations, alternatives, and equivalents are possible within the scope of the claims. For example, in one such alternative, if it is determined, for example, as a result of operation 320 and/or operation 332, that failure to establish and/or maintain communication has occurred, processing in this embodiment may loop back to operation 312 and/or operation 324, respectively. Thereafter, one or more additional iterations of operations 312, 314, 316, 318, and 320, and/or one or more iterations of operations 324, 326, 328, 330, and 332 may be executed without departing from this embodiment. Also alternatively, without departing from this embodiment, operations 324, 326, 328, 330, and 332 may be eliminated. Accordingly, the claims are intended to cover all such modifications, variations, alternatives, and equivalents.

What is claimed is:

1. A method comprising:
selecting, from a plurality of ranges of amplitudes, a first range of amplitudes that includes a first amplitude of a signal received via a communication medium;
selecting a second amplitude of a signal to be transmitted via the communication medium, the second amplitude being comprised in a second range of amplitudes comprised in the plurality of ranges of amplitudes, the second amplitude being selected based, at least in part, upon the selected first range of amplitudes.

2. The method of claim 1, wherein:
the second amplitude is less than a predetermined signal transmission amplitude, according to a communication protocol; and
the method further comprises:
attempting to at least one of establish and maintain communication, in accordance with, at least in part, the communication protocol; and
in response, at least in part, to a failure to the at least one of establish and maintain the communication, selecting, a third amplitude of another signal to be transmitted via the communication medium, the third amplitude being greater than the second amplitude.

3. The method of claim 1, wherein:
the first range of amplitudes and the second range of amplitudes are different from each other.

4. The method of claim 3, wherein:
the second amplitude is less than the first amplitude.

5. The method of claim 1, wherein:
the method further comprises, after a failure to at least one of establish and maintain communication, in accordance at least in part with a communication protocol, selecting, a third amplitude of another signal to be transmitted via the communication medium;
one of the plurality of ranges of amplitudes comprises a predetermined signal transmission amplitude in accordance with the protocol;
the first range of amplitudes comprises the predetermined signal transmission amplitude; and
the third amplitude is comprised in a third range of amplitudes different from the first range of amplitudes and the second range of amplitudes.

6. The method of claim 1, wherein:
the method further comprises, after a failure to at least one of establish and maintain communication, in accordance at least in part with a communication protocol, selecting, a third amplitude of another signal to be transmitted via the communication medium, the third amplitude being a predetermined transmission signal amplitude in accordance with the communication protocol; and
a lowest amplitude in the second range of amplitudes is greater than a greatest amplitude in the first range of amplitudes.

7. The method of claim 1, wherein:
the method further comprises, after a failure to at least one of establish and maintain communication, in accordance at least in part with a communication protocol, selecting, a third amplitude of another signal to be transmitted via the communication medium, the third amplitude being comprised in the first range of amplitudes; and
the second range of amplitudes being different from the first range of amplitudes.

8. An apparatus comprising:
circuitry to select, from a plurality of ranges of amplitudes, a first range of amplitudes that includes a first amplitude of a signal received via a communication medium, the circuitry also being capable of selecting a second amplitude of a signal to be transmitted via the communication medium, the second amplitude being comprised in a second range of amplitudes comprised in the plurality of ranges of amplitudes, the circuitry being capable of selecting the second amplitude based, at least in part, upon the selected first range of amplitudes.

9. The apparatus of claim 8, wherein:
the second amplitude is less than a predetermined signal transmission amplitude, according to a communication protocol; and
the circuitry is also capable of attempting to at least one of establish and maintain communication, in accordance with, at least in part, the communication protocol, and in response, at least in part, to a failure to the at least one of establish and maintain the communication, the circuitry also being capable of selecting, a third amplitude of another signal to be transmitted via the communication medium, the third amplitude being greater than the second amplitude.

10. The apparatus of claim 8, wherein:
the first range of amplitudes and the second range of amplitudes are different from each other.

11. The apparatus of claim 10, wherein:
the second amplitude is less than the first amplitude.

12. The apparatus of claim 8, wherein:
the circuitry is also capable of, after a failure to at least one of establish and maintain communication, in accordance at least in part with a communication protocol, selecting, a third amplitude of another signal to be transmitted via the communication medium;
one of the plurality of ranges of amplitudes comprises a predetermined signal transmission amplitude in accordance with the protocol;
the first range of amplitudes comprises the predetermined signal transmission amplitude; and
the third amplitude is comprised in a third range of amplitudes different from the first range of amplitudes and the second range of amplitudes.

13. The apparatus of claim 8, wherein:
the circuitry is also capable of, after a failure to at least one of establish and maintain communication, in accordance at least in part with a communication protocol, selecting, a third amplitude of another signal to be transmitted via the communication medium, the third amplitude being a predetermined transmission signal amplitude in accordance with the communication protocol; and
a lowest amplitude in the second range of amplitudes is greater than a greatest amplitude in the first range of amplitudes.

14. The apparatus of claim 8, wherein:
the apparatus is also capable of, after a failure to at least one of establish and maintain communication, in accordance at least in part with a communication protocol, selecting, a third amplitude of another signal to be transmitted via the communication medium, the third amplitude being comprised in the first range of amplitudes; and
the second range of amplitudes being different from the first range of amplitudes.

15. An article comprising:
a storage medium having stored thereon instructions that when executed by a machine result in the following:
selecting, from a plurality of ranges of amplitudes, a first range of amplitudes that includes a first amplitude of a signal received via a communication medium;
selecting a second amplitude of a signal to be transmitted via the communication medium, the second amplitude being comprised in a second range of amplitudes comprised in the plurality of ranges of amplitudes, the second amplitude being selected based, at least in part, upon the selected first range of amplitudes.

16. The article of claim 15, wherein:
the second amplitude is less than a predetermined signal transmission amplitude, according to a communication protocol; and
the instructions when executed also result in:
attempting to at least one of establish and maintain communication, in accordance with, at least in part, the communication protocol; and
in response, at least in part, to a failure to the at least one of establish and maintain the communication, selecting, a third amplitude of another signal to be transmitted via the communication medium, the third amplitude being greater than the second amplitude.

17. The article of claim 15, wherein:
the first range of amplitudes and the second range of amplitudes are different from each other.

18. The article of claim 17, wherein:
the second amplitude is less than the first amplitude.

19. The article of claim 15, wherein:
the instructions when executed also result in, after a failure to at least one of establish and maintain communication, in accordance at least in part with a communication protocol, selecting, a third amplitude of another signal to be transmitted via the communication medium;
one of the plurality of ranges of amplitudes comprises a predetermined signal transmission amplitude in accordance with the protocol;
the first range of amplitudes comprises the predetermined signal transmission amplitude; and
the third amplitude is comprised in a third range of amplitudes different from the first range of amplitudes and the second range of amplitudes.

20. The article of claim 15, wherein:
the instructions when executed also result in, after a failure to at least one of establish and maintain communication, in accordance at least in part with a communication protocol, selecting, a third amplitude of another signal to be transmitted via the communication medium, the third amplitude being a predetermined transmission signal amplitude in accordance with the communication protocol; and
a lowest amplitude in the second range of amplitudes is greater than a greatest amplitude in the first range of amplitudes.

21. The article of claim 15, wherein:
the instructions when executed also result in, after a failure to at least one of establish and maintain communication, in accordance at least in part with a communication protocol, selecting, a third amplitude of another signal to be transmitted via the communication medium, the third amplitude being comprised in the first range of amplitudes; and
the second range of amplitudes being different from the first range of amplitudes.

22. A system comprising:
a circuit board comprising a circuit card slot;
a circuit card capable of being coupled to the slot, the circuit card comprising circuitry to select, from a plurality of ranges of amplitudes, a first range of amplitudes that includes a first amplitude of a signal received via a communication medium, the circuitry also being capable of selecting a second amplitude of a signal to be transmitted via the communication medium, the second amplitude being comprised in a second range of amplitudes comprised in the plurality of ranges of amplitudes, the circuitry being capable of selecting the second amplitude based, at least in part, upon the selected first range of amplitudes.

23. The system of claim 22, wherein:
the circuit board comprises a bus and a host processor coupled to the bus; and
when the circuit card is coupled to the slot, the circuitry is coupled to the bus.

24. The system of claim 22, wherein:
the second amplitude is less than a predetermined amplitude, according to a communication protocol, for the signal to be transmitted.

25. The system of claim 24, wherein:
the communication protocol is an Ethernet protocol.

26. The system of claim 24, wherein:
the communication medium comprises a cable to couple the circuitry to a network node, the circuitry being capable of transmitting to the network node, via the cable, at the second amplitude, the signal to be transmitted.

27. The system of claim 26, wherein:
the cable is capable of propagating to the circuitry the signal received via the communication medium.

28. The system of claim 22, wherein:
the first amplitude indicates, at least in part, a signal attenuation characteristic of the communication medium.
